(19) United States
(12) Patent Application Publication
(10) Pub. No.: US 2016/0328754 A1
(43) Pub. Date: Nov. 10, 2016

(54) Method and System to Facilitate e-Commerce Transactions at a Host Website

(71) Applicants: Robert Gold, Manalapan, NJ (US); Scott Vogt, Chester, NJ (US); Jason M. Rappaport, Staten Island, NY (US); Jason A. Howie, Clark, NJ (US)

(72) Inventors: Robert Gold, Manalapan, NJ (US); Scott Vogt, Chester, NJ (US); Jason M. Rappaport, Staten Island, NY (US); Jason A. Howie, Clark, NJ (US)

(21) Appl. No.: 14/545,600

(22) Filed: May 7, 2015

(51) Int. Cl. G06Q 30/02

(52) U.S. Cl. CPC G06Q 30/0277

(57) ABSTRACT

A method and system to facilitate e-commerce and improve possibilities of revenue distribution by enabling third party advertisement Providers to present ads on a Publisher's Website where the user can activate the ad and complete the purchase without ever leaving the Website. This two tier micro service approach of application suite supported by an array of more surgical procedures, allows the user or consumer, without leaving the Publisher's Website, to activate the ad itself to be clicked to purchase or acquire the offered goods or services. This alters the way e-commerce typically works by keeping traffic on the Publisher's website. The customer never leaves the site. All relevant data is seamlessly brought into the ad window. The size of the ad window may be expanded if required. The visiting customer is not redirected anywhere.

The present invention is directed to a presentation and a transactional engine, which are coupled together to provide an improved experience for purchasers of goods.

### BACKGROUND

In genera!, browsing internet users are presented with various sized ad units when they visit differing source web sites. At times, these ads are embedded within a web page. Typically these ads are directed to products or services which are purchasable on the internet. In general, when consumers visit web sites, multiple ads units may appear in these web site presentations. When a consumer sees an ad placement and they have interest in the ad or in purchasing the product in the ad, the consumer can dick on the ad.

When a consumer interacts with (such as clicking on} the ad, the consumer often is directed to another web site {referred to as the “landing page”) with content related to the ad and, at times, the consumer may be afforded the opportunity to purchase a product. In general, the landing page resides on another web site within a different domain and appears in a different browser window or in a different or its own app. The consumer is afforded the opportunity to make or purchase from that locale. When such a purchase is made, the purchase is from the holder of the landing page, not from the source web site provider.

As noted, a landing page generaHy resides on a different domain than the source web site which had been hosting the ad. Once the ad is clicked, the landing page will then reinforce the offer and provide the consumer with the next steps to purchase and checkout

Ordinarily, an advertiser might pay the source web site provider a fee based on the ad placement and, perhaps, for the click-through, however, less often are source websites likely to use commission based advertising. By implementing a variation where the ad itself can be clicked to purchase, an opportunity for a change in fee payment can be implemented. Further, the source web site provider can track purchases and related data regarding, for example, click movement of the consumer. That is, because the source web site provider can determine which click-throughs result in purchases, the web site providers may be afforded with a new, commission-based revenue opportunities.

Similarly, a consumer may find such a process beneficial as well in that she/he needn't move to a different screen or different provider-thereby reducing the likelihood of downtime and avoiding annoying changes in displays.

Other problems exist with the present method as well. Traditional e-commerce ads on a source web site provider's (or “publisher's”) site provide the source web site provider with the option to re-direct the consumer to the e-commerce site or landing page thereby losing the consumer and their potential for seeing more content and ad units. Alternatively, the publisher at his/her option can make thee-commerce site available via a new window or tab also distinct from the publisher's site. These scenarios could be inhibited by the consumer's security settings and this solution thus is not an ideal consumer experience and the source web site would still lose the consumer's focus after completing the transaction.

Traditional checkout buttons on e-commerce pages are typically static calls to action and do not stress enough urgency to compel consumers to make purchases Impulsively. To help address this concern, some sites will add countdown timers and quantities in the vicinity of the checkout button, but there often are overlooked by consumers because of the apparent de-emphas.is of the text versus the emphasis on checkout button and price.

Further, for purposes of branding, it may be beneficial for the source web site to remain visible and in the same window to the consumer during the purchase process.

In addition, it would be beneficial for a web site provider to provide additional information directly to the consumer while the ad is present and/or while the purchase screens are visible within the context of the web site's other material. For example, the web site provider may provide incentive to the consumer to purchase soon by providing visible indication of the number of units remaining to be purchased, the frequency with which others are purchasing the product, short term price changes, or other incentives.

### DESCRIPTION OF THE INVENTION

The present invention is directed to a responsive shopping cart embedded into ad units that either conforms to its available display areaor generates in an overlay on the same page without redirecting the consumer to a different website domain or application. The consumer can view product, its options, and then complete a purchase transaction, all while remaining on the source web page, thus allowing the software provider to retain valuable traffic. The ad contains responsive technology that reacts to the device and format used by the consumer for an ideal experience that allows for a quick user-friendly transaction.

The present invention is applicable to computers, tablets, and other mobile devices, such as cellphones which have internet access also known as smart phones.

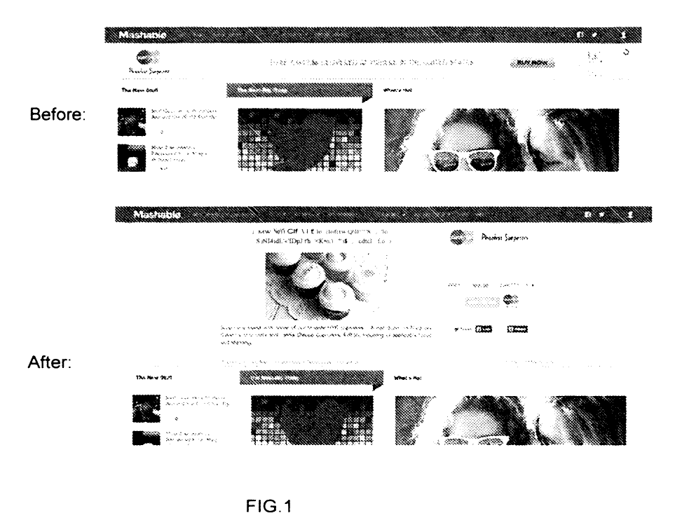

In the present invention, a web site includes a responsive or expanding ad. When the consumer interacts (clicks) with the ad unit, instead of being taken to a new webpage or to a page which opens in a different application, the ad itself become interactive and further responsive. The responsive cart and checkout process while hosted on another domain is completely embedded in the ad unit on the source web site. See FIG. 1 as an example, which shows before and after images of the ad in the web page.

In the preferred embodiment, once the web page is delivered to the consumer and once the consumer clicks on the ad, the content in the ad changes (and, potentially, the size of the ad changes within the web page). The content being provided is delivered from content stored on the web site's server or servers. That is, the back content of the clicked ad is provided from the originator of the web site and is not pulled in from another source. The new content is further responsive and preferably includes the consumer's ability to purchase an advertised product. That is, even though a product may merely be pictured in the ad initially, the evolving content allows the consumer with the ability to select the specific product they would like, such as by color or size, and to place an order and pay for the order. The benefits of providing self-populated content include both control over the content and the ability to further track consumer clicks and collect revenue.

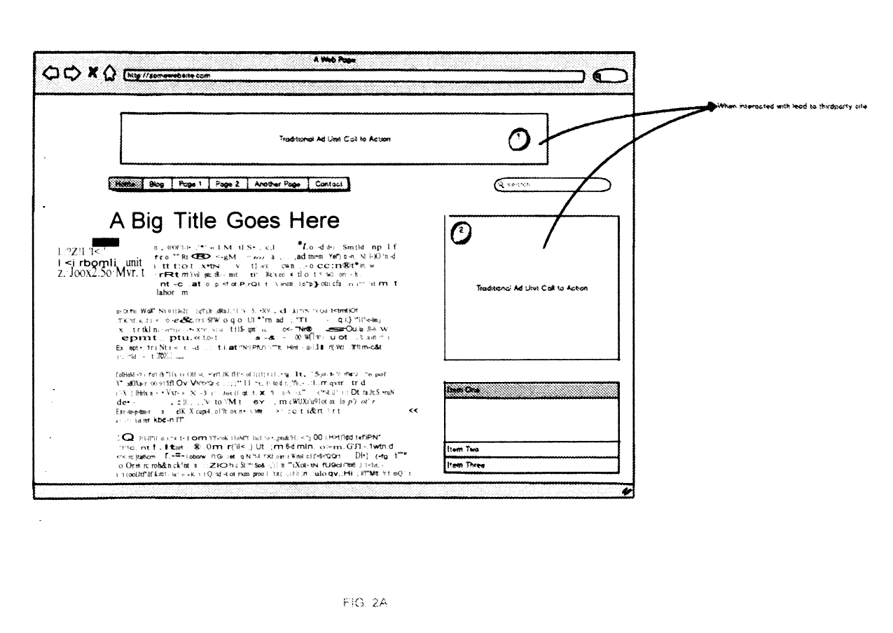

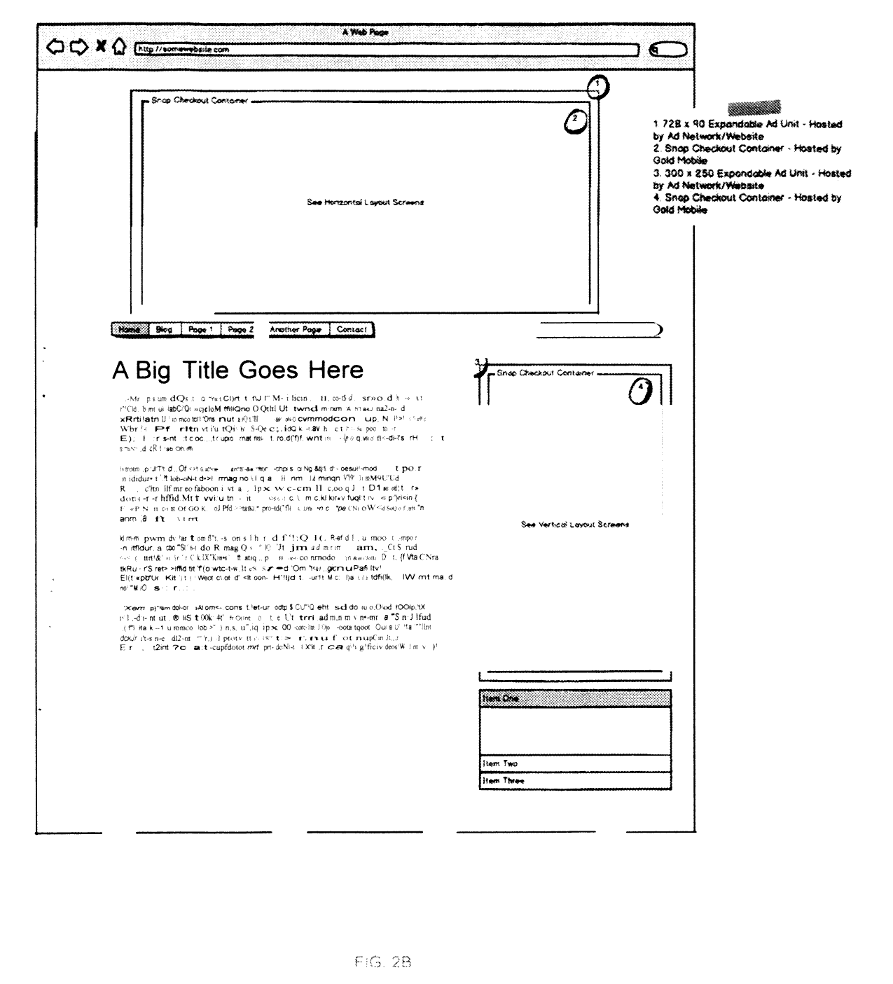

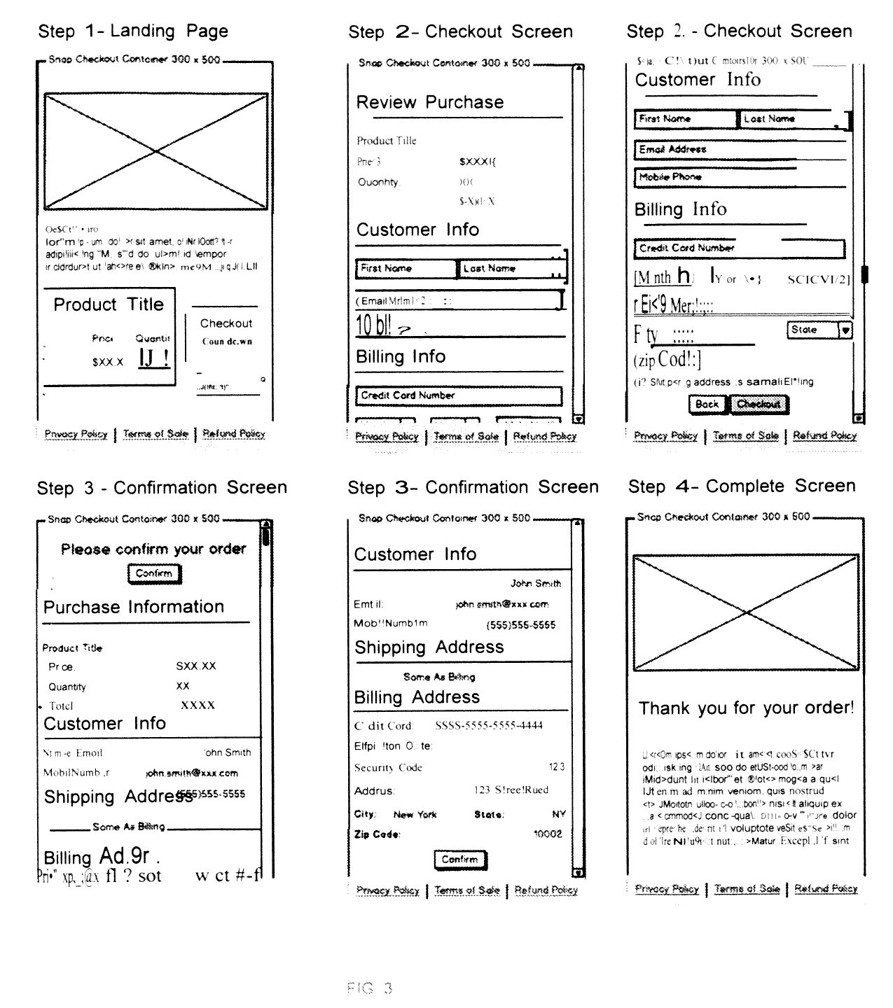

FIGS. 2A and 28 show examples of placement of an ad in the context of the present invention. FIG. 3 shows examples of changing content in the ad position.

The present invention further utilizes inventory controls and computer specific tracking to display the offering, even when the offer is limited in nature, within the checkout button itself. Coming in at least two flavors this can be a countdown of stock still available for purchase, or a countdown of time left for the consumer to make her/his purchase. In this embodiment of the present invention, the source web site provider either has or has access to key inventory data in real time regarding the product An algorithm is implemented by the hester of the ad so as to have available real-time inventory for processing and/or display to the consumer so as to facilitate product purchase. For example, the consumer can be provided with a display of the number of items remaining in inventory, which may change as the inventory changes. The remaining inventory quantity can be presented to a consumer in real-time and updated as the inventory quantity is revised.

The source website provider can track activity with respect to each product offered, and may do so in real time. In another example, if sales are brisk (or slow}, the algorithm can change the price or inform the consumer that the price will change in x minutes. By incorporating this information in real-time in the checkout button, the e-commerce site and ad units can stress urgency to the consumer to make the purchase while supplies/time is still available.

In summary, the present invention includes a method and set of equipment to facilitate consumer purchase and improve possibilities of revenue distribution. The new components of this checkout method include:
The consumer doesn't leave the source web site by clicking on the ad to complete the purchase. This encourages purchases by reassuring tl1e consumer of where they are buying from, and provides the source website additional opportunities for increase ad unit views from consumers who aren't directed away from the site by traditional ad units.
The checkout button stresses urgency to the consumer in a way that helps ensure visibility of the countdown quantities/timers, give the consumer a clear call to action.

1. A method of electronic commerce over the web using advertisements for display on a webpage, having advertisements from either the publishing website (first server) or from a third part provider (second server), using data from a different server (third server) to manage the transaction while keeping the user on the publisher's website, the method comprising:
a. Displaying an advertisement on a webpage;
i. Wherein the source of that ad may be from the publisher or from a third party provider; and
ii. Wherein the location and size of that ad may be variable; and
iii. Wherein the advertisement displays at least one active link;
b. responding automatically to the activation of an active link by the user by communicating with a destination server different from the website and different from the third party ad provider, and while leaving the user still at the source website;
c. responding automatically by said destination server by establishing a secure communication link with the website server;
d. responding automatically by said destination server by sending data for interactive responses to the user still at the original website;
i. Wherein the response may be confined to the original ad space or it may use more of the webpage area for display, and
ii. Wherein there may be several or more exchanges of information presentation to the user and responses back;
e. Acting on the user's responses by the destination server by making requests to other applications and procedures running on the destination server;
i. Wherein there are a variety of procedures running on said destination server to perform authentications, manage databases, query a database about inventory levels, complete payment operations, manage customer reward accounts, send confirming emails' f. Ending the secure communications link after all steps of the transaction are completed.
